(19) United States
(12) Patent Application Publication
(10) Pub. No.: US 2013/0086079 A1
(43) Pub. Date: Apr. 4, 2013

(54) GRAPHICAL USER INTERFACE FOR INTERACTING WITH AUTOMATICALLY GENERATED USER PROFILES

(71) Applicants: Abhimanyu Chaudhuri, Santa Clara, CA (US); Aniruddha Chaudhuri, Los Altos, CA (US); Pankaj Anand, Cupertino, CA (US); Matthew Donald Polky, Terre Haute, IN (US); Philip John Vander Broek, Holland, MI (US); Zachary James Koch, San Francisco, CA (US); Pankaj Mehra, San Jose, CA (US)

(72) Inventors: Abhimanyu Chaudhuri, Santa Clara, CA (US); Aniruddha Chaudhuri, Los Altos, CA (US); Pankaj Anand, Cupertino, CA (US); Matthew Donald Polky, Terre Haute, IN (US); Philip John Vander Broek, Holland, MI (US); Zachary James Koch, San Francisco, CA (US); Pankaj Mehra, San Jose, CA (US)

(21) Appl. No.: 13/252,687

(22) Filed: Oct. 4, 2011

(51) Int. Cl. G06F 17/30

(52) U.S. Cl. 707/748; 707/E17.005

(57) ABSTRACT

A robust knowledge-based management and sharing system organized by context for context-based searching and retrieval of relevant information is disclosed. The described embodiments and techniques are used to automatically generate user profile data and organize it around one or more contexts associated with users such as their projects, products, or customers; or around users' expertise such as their competencies, knowledge, and experience. At least certain embodiments include a graphical user interface that is configured to display the automatically generated user profiles categorized based on a given expertise or context associated with the end-user.

### FIELD OF THE INVENTION

At least certain embodiments of the invention relate generally to electronic display systems, and more particularly to a graphical user interface for interfacing with a system that provides automatically generated user profile information.

### BACKGROUND

In large organizations, communities, and networks people often communicate and collaborate with others they know or are directly connected to. But there are limited ways to search for or discover other people within a particular organization or community who are relevant to a current need that an individual may be interested in. One way to do this is by using user profiles to find persons relevant to a particular task or project because user profiles typically contain information that describes a user. Traditional search techniques look for high-level keywords or descriptions in an individual's user profile. These profiles must be manually updated by the user from time to time, which can be a time consuming and tedious activity. Since updating one's profile is a manual activity, a search for a particular individual's profile could obtain search results that are stale or no longer relevant.

### SUMMARY

Various methods, devices, and systems are disclosed for providing a graphical user interface for a robust knowledge-based management and sharing system organized by context for context-based searching and retrieval of relevant information. The embodiments and techniques described herein are used to automatically generate user profile data and organize it around one or more contexts associated with the users, such as users' projects, products, or customers or users' expertise such as their competencies, knowledge, and experience. At least certain embodiments are configured to display the automatically generated user profiles categorized based on a given expertise or context associated with the end-user to facilitate various levels of user interaction with the profiles.

### BRIEF DESCRIPTION OF THE DRAWINGS

For a better understanding of at least certain embodiments, reference will be made to the following Detailed Description, which is to be read in conjunction with the accompanying drawings, wherein:

FIG. 1 depicts an illustrative embodiment of a profile view in a graphical user interface for interacting with automatically generated user profiles.

FIG. 2A depicts an illustrative embodiment of a profile view in a graphical user interface corresponding to the embodiment of FIG. 1.

FIG. 2B depicts an illustrative embodiment of a faceted search view in a graphical user interface for interacting with automatically generated user profiles.

FIG. 3 depicts an illustrative embodiment of an edit profile view in a graphical user interface for interacting with automatically generated user profiles.

FIG. 4 depicts an illustrative embodiment of an edit profile view in a graphical user interface corresponding to the embodiment of FIG. 3.

FIG. 5 depicts an illustrative embodiment of a process for interacting with a graphical user display configured for displaying automatically generated user profiles.

FIG. 6 depicts an illustrative data processing system upon which the methods and apparatuses of embodiments may be implemented.

### DETAILED DESCRIPTION

Throughout the description, for the purposes of explanation, numerous specific details are set forth in order to provide a thorough understanding of the present invention. It will be apparent to one skilled in the art, however, that the present invention may be practiced without some of these specific details. In other instances, well-known structures and devices are shown in block diagram form to avoid obscuring the underlying principles of embodiments of the invention.

Various methods, devices, and systems are disclosed for providing a robust knowledge-based management and sharing system organized by context for context-based searching and retrieval of relevant information. The embodiments and techniques described herein are used to automatically generate user profile data and organize it around one or more contexts associated with the users such as their projects, products, or customers; or around their expertise such as their competencies, knowledge, and experience. At least certain embodiments include a graphical user interface that is configured to display the automatically generated user profiles categorized based on a given expertise or context associated with the end-user.

The methods and devices disclosed herein are configured to receive an indication of a known interest of the end-user and to display a list of user profiles that match the known interest of the end-user in rank order. In one embodiment, a profile building unit is provided within the system to perform the automatic generation of the set of user profiles organized around a given expertise or context. The profile building unit may be implemented in computer hardware, software, or combination thereof. In addition, the profile building unit may be implemented in the device itself, or may be received as modules over a wired or wireless network connection. An illustrative embodiment of a system that includes a profile building unit is described in U.S. patent application Ser. No. 13/197,711 entitled, “Automated Generation and Discovery of User Profiles,” filed on Aug. 3, 2011 (“the '711 application”), the disclosure of which is expressly incorporated by reference in its entirety. Each automatically generated user profile can also be ranked based its strength of relationship with the expertise or context. In one embodiment, a scoring unit is provided to perform the ranking of each of the user profiles, an example embodiment of which is shown and described in the '711 application.

In addition, at least some end-user profile information can be used to determine which automatically generated user profiles to display based on the strength of the relationship between the information contained in the end-user's profile and the user profiles that are automatically generated. The known interest of the end-user can therefore be based on the expertise or context associated with information contained in the end-user's profile (“end-user profile information”). In this way, the end-user's profile information acts to mediate the search and retrieval of automatically generated user profiles for display. Alternatively, the known interest of the end-user can be determined directly based on a search query input by the end-user. The search queries can be used independently, or in combination with, the end-user profile information to return highly relevant search results. This information can be of further defined based on additional user input of a search context in addition to, or in combination with, a search query and end-user profile information.

Embodiments of the graphical user interface are configured to display lists of user profiles organized into categories based on their relationship to a given expertise or context. The graphical user interface can display the user profiles that match a known interest of the end-user in rank order. The displayed user profiles can include user information such as name, title, a role, location, and a short textual description of the user. The display of user profiles also includes a list of one or more profile information items (“PII”) organized into groups in the display based on the given expertise or context. The profile information items are data that is relevant to a given expertise or context associated with the user. The profile information items may include, for example, data associated with the user's professional or work-related activities, projects, products, customers; or data associated with the user's expertise, competencies, knowledge, experience, or connections. The profile information items may be, for example, keywords or phrases related to concepts that have relevancy to the given expertise or context.

In at least certain embodiments, the graphical user interface includes a profile view and an edit profile view. The profile view is configured for searching for and displaying user profiles relevant to the expertise or context. The search can be performed based on, and hence mediated by, the information contained in the end-user's profile. As described in detail below, searches may be performed automatically, upon selection of a particular profile information item in the end-user's profile, using a search query, using a search context, or any combination of these in order to retrieve highly relevant results. The edit profile view is configured for annotating the end-user's own profile information and for controlling display options of end-user profile information. As such the end-user can control the display of user profile information irrespective of its relevancy to the expertise or context using these selections within the graphical user interface window. For example, an end-user can hide, delete, or reveal individual line items residing within the user's profile information. In one embodiment, a control unit is provided to receive the control selections from the end-user and to adjust the display of user profile information in response, an example embodiment of which is shown and described in the '711 application. In addition, as used herein, any selectable controls disclosed include buttons, clickable icons, or any spoken, gesture-based, touch-based, or other interface technologies to support selection as is well-known and expected in the art.

At least certain embodiments are additionally configured to receive feedback from users and to adjust the display of the user profile information in response to this feedback. For example, embodiments include functionality configured to enable the end-user to make selections in a graphical user interface window in order to validate the quality of the end-user's own automatically generated user profile. Such selections by the end-user result in annotations being added by the system to the end-user's profile, which train various functions such that the user's selections and preferences will be taken into account for future automatic user profile generation and discovery. In one embodiment, a competency detection unit is provided to receive this feedback from users and to annotate the user profiles in response thereto, an example embodiment of which is shown and described in the '711 application.

The user profile information can also be presented in the form of an electronic index card as described in detail below. This allows the information in each profile to be manipulated and managed in a variety of ways to mimic a physical index card such as by adding notations, reminders, organizing cards in a drawer (e.g., window) with various categorization options, etc. Individual profile information items therefore may be added to, removed from, or transferred between the user profiles much in the same way as can be done with physical index cards.

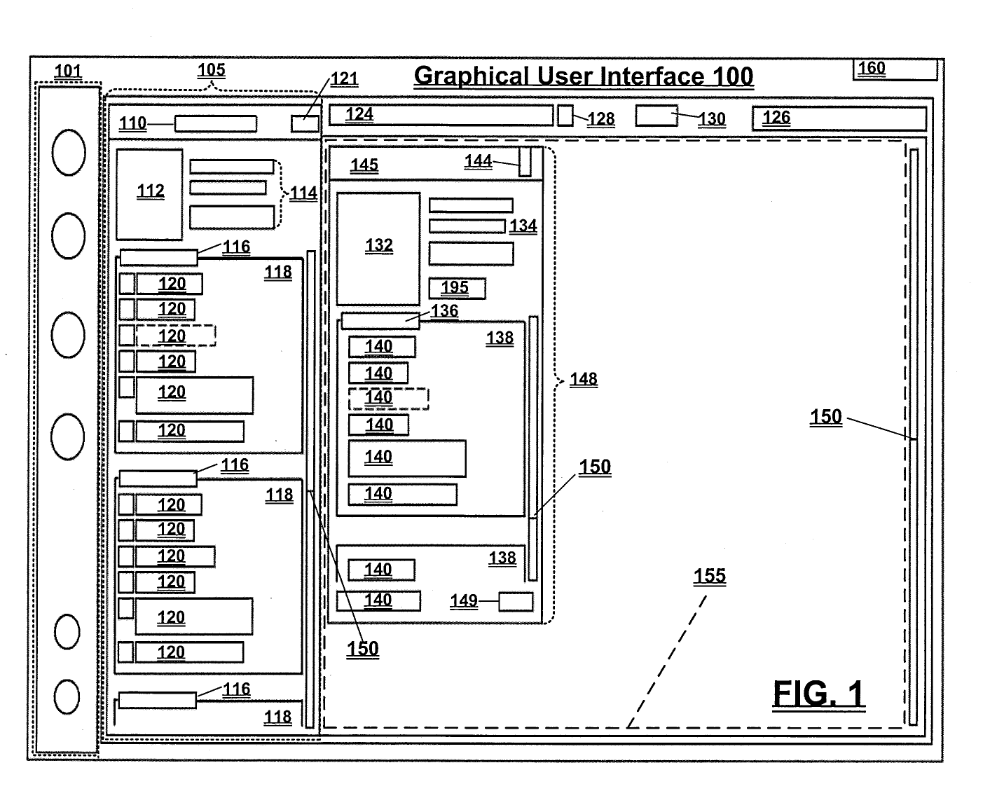

Embodiments disclosed herein include displaying user profiles to the end-user. FIG. 1 depicts an illustrative embodiment of a profile view in a graphical user interface for interacting with automatically generated user profiles. In the illustrated embodiment, graphical user interface 100 is in profile view mode that would typically be displayed on a computer or a mobile computing device such as a tablet or smartphone, either as a stand-alone application or rendered inside the context of another application, such as an Internet browser or email client. In the profile view of FIG. 1, there are a number of commonly used controls 160, such as Windows controls for example, that are used to maximize, minimize, resize, and close graphical user interface 100. Other controls include scrollbars 150 in the illustrated embodiment. Main navigation controls 101 contain the primary navigational elements, allowing a user to toggle between different modes of interaction with one or more user profiles. The profile view further includes a representation of the end-user's profile in profile pane 105. As discussed above, profiles may be depicted in a format similar to an electronic index card populated with profile information of the end-user. Such user profile information can be automatically generated by the system. Profile pane 105 provides a context within which the end-user can view any set of profile information items (120, 140) in a highly personalized fashion. In the illustrated embodiment, profile pane 105 includes user information such as username 110, profile image 112, and other user contextual information 114 such as biographical and professional information.

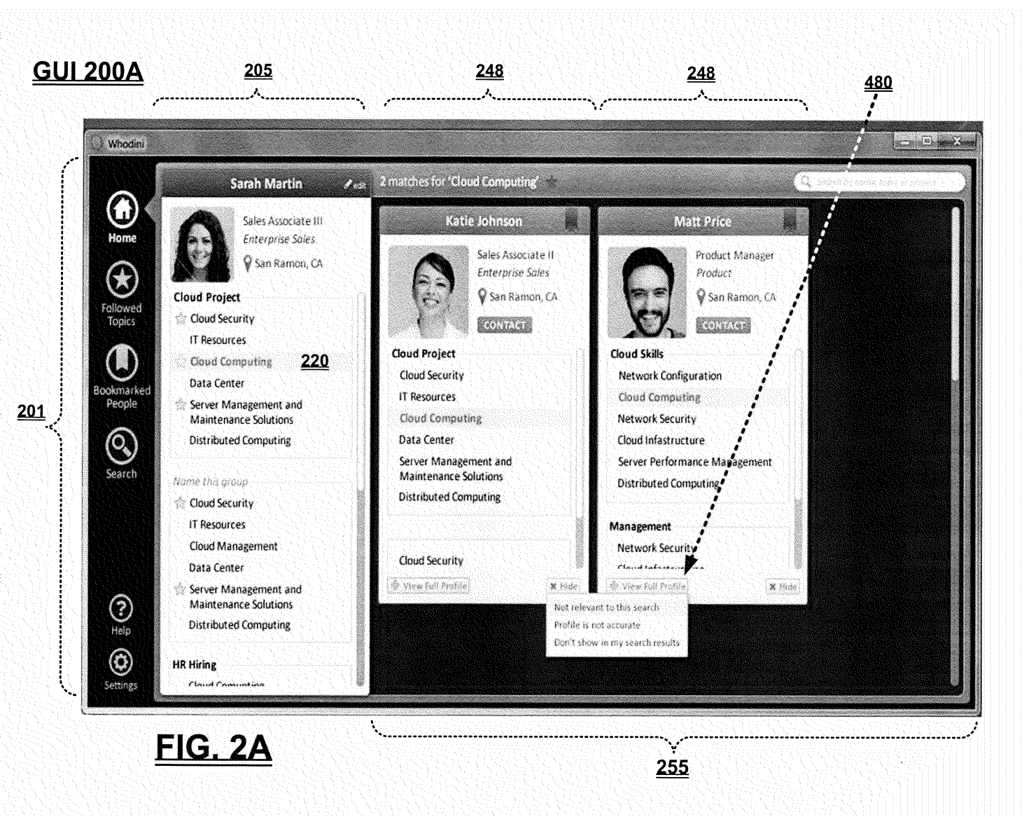

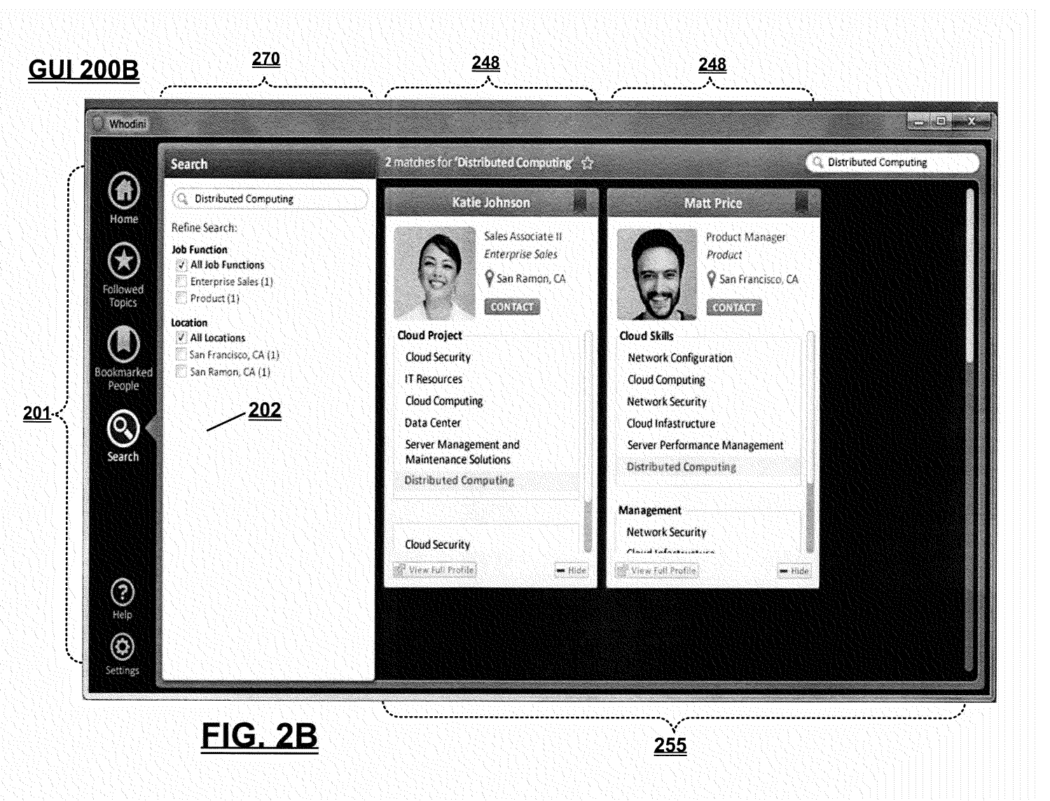

The end-user's profile also includes various groups 118 of the end-user's expertise or context. Each group 118 of user expertise or context includes its own set of profile information items 120 contained in the profile pane 105 of the end-user's profile. Each of the profile information items 120 can be individual relevant keywords, phrases or concepts within a particular expertise or context of the end user, group together in groups 118, which can be of varying sizes. Each profile information items group 118 may have its own group title or heading 116 that describes its contents, and is either user provided or system generated. This grouping of profile information items 120 allows the user to navigate through and interact with them as desired. In one embodiment, each profile information item 120 may be mapped to multiple groups 118. A user can select the edit profile button 121 in order to enter into edit profile mode, shown and described in FIG. 2.

Profile pane 105 supports numerous interactions with the profile information items 120 contained in it. In at least certain embodiments, the user interaction with the profile information items 120 consists of selecting a particular item 120 by clicking or hovering over it with a mouse. This action retrieves and displays a listing of recommended automatically generated user profiles 148 that match the profile information item 120 that was selected. These user profiles 148 populate results pane 155 and each contain data relevant to a particular expertise or context. In one embodiment this listing of profiles 148 is displayed in rank order based on the strength of the relationship between each user profile 148 and the particular expertise or context associated with a selected profile information item 120. Each automatically generated user profile 148 includes its own user information such as username 110, profile image 112, and other user contextual information 114 such as biographical, professional, or work-related information; and each recommended profile 148 includes a scrollable listing of its own profile information items 140 (or snippets thereof) that caused the match with the selected profile information item(s) 120 or user query (124, 126). As in the case of the end-user profiles in profile pane 105, each set of profile information items 140 are organized in groups 138 of various sizes and accessed using a scrollbar 150.

The automatically generated recommended user profiles 148 are retrieved and displayed in results pane 155 in response to a user's selection of a particular profile information item 120 in profile pane 205, in response to entering a search query into search box 126, in response to entering a search context into search context bar 124, or any combination of these. Each of these resulting automatically generated user profiles 148 is organized and displayed by the degree of its relevance to the selected profile information item 120 or search query (124, 126). Search box 126 is a representative text entry area for the user to input ad hoc search queries for receiving profile recommendations 148 in results pane 155. This user input can be supplemented by the context of the end-user derived from the user's own profile information. In this embodiment, the delivery of content can be further influenced (e.g. mediated) by the context and other information contained within the end-user's own profile. This is referred to herein as profile-mediated interaction (“PMI”). Therefore, the search can be pre-informed (or pre-contextualized) as to the end-user's context, thereby returning possibly different results for different users depending on their respective contexts. Irrespective of the mode of retrieval, a confirmation of the contextualizing item along with the count of result pane 155 items is posted into the search context bar 124. Thus, the combination of profile pane 105 and results pane 155 working together results in contextual delivery of targeted content or contextual recommendations in any form.

A user can interact with recommended user profiles 148 in multiple ways. People within an organization or team that correspond to each of the profiles 148 can be contacted by selecting contact control button 195. Selecting contact control button 195 initiates a dialog interaction for sending and receiving electronic messages to the respective person. The message can be auto-generated based on profile information of, and the relationship between, the end-user and the system recommended user. The message may alternatively be composed by the end-user manually. The message may take the form of asynchronous communication (e.g., e-mail), interactive voice communication (e.g., telephone call, or VoIP call such as Skype), text message, real-time communication (such as Microsoft Communicator, any text-based chat application, Apple FaceTime or other video chat), or any other means of communication. Alternatively, selecting the contact control 195 May result in creation of a calendar meeting request, a screen sharing session, or other form of scheduled interactive communications. As with messages above, the requests for a scheduled interactive communications may be manually edited by the end-user, entirely automatically generated, or some combination of these.

Moreover, user profiles 148 can be bookmarked for future reference by selecting the bookmarked control button 144. Also, by clicking on a detailed profile information control button (not shown), users can either examine the user profiles 140 in more detail, or inspect a visual representation of various factors that contributed to the match. In addition, users can hide a particular user profile 148 (temporarily or permanently) by selecting on the high profile button 149. User profiles 148 can also be retrieved through subscription. Subscribe control button 128, for example, can be used to toggle control for the user to indicate their continued interest in a particular search context or query. Selecting this control 128 results in the user being notified on an ongoing basis when new matches are available. The end-user may discontinue further notifications by toggling control 128 again.

The profile view of the graphical user interface may be implemented in a variety of ways, and the techniques disclosed herein are not limited to any particular implementation, but are shown and described for purposes of explanation. FIG. 2A depicts an example embodiment of a profile view in a graphical user interface corresponding to the embodiment of FIG. 1. The illustrated embodiment depicts a profile view of the graphical user interface 200A that includes main navigation controls 201 and a user profile pane 205. As in FIG. 1, profile pane 205 contains various groups of profile information items 220 organized in groups based on user expertise or context. The profile view of graphical user interface 200 further includes various recommended user profiles 248 displayed in results pane 255. This embodiment also shows an exemplary set of controls that can be used by the end-user to annotate profiles 248 including the removing a particular profile from the search results or notifying the system of an inaccurate profile 248.

In addition, a faceted (or customized) search may optionally be performed by selecting a faceted search control button to reduce the number of recommended user profiles 148 splayed in results pane 155. FIG. 2B depicts an illustrative embodiment of a faceted search view in a graphical user interface for interacting with automatically generated user profiles. In the illustrated embodiment, graphical user interface 200B includes a faceted search control button 202 among the main navigation controls 201. The faceted search control button is configured to make available a variety of options to narrow the search results such as by location, job, title, job function, social graph distance, or measures of helpfulness. A faceted search can be performed by selecting the options in search box 270 of the graphical user interface. Once a faceted search is performed, recommended user profiles 248 matching the search criteria are displayed in results pane 255 based on relevance to the search criteria as before.

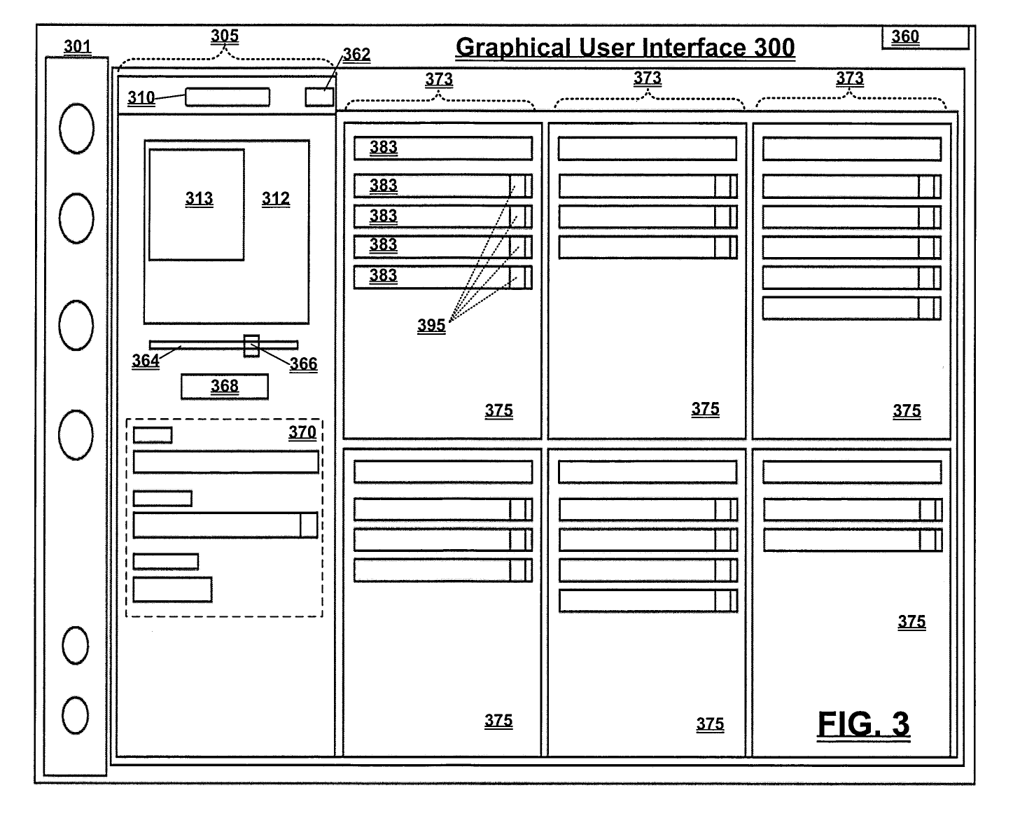

Embodiments also disclose ways of editing user profiles. FIG. 3 depicts an illustrative embodiment of an edit profile view in a graphical user interface for interacting with automatically generated user profiles. In the illustrated embodiment, graphical user interface 300 is in an edit profile view mode. This mode allows the end-user to edit various aspects of their user profile information and is similar to the profile view of FIG. 1 in that it includes main navigation controls 301 and a number of commonly used controls 360 to maximize, minimize, resize, and close graphical user interface 300. Edit profile view further includes a representation of the end-user's profile and edit profile pane 305, which provides a context within which the end-user can view any set of profile information items 383 and to edit those items accordingly using various controls. For example, edit profile pane 305 contains controls (310, 312, 313, 370) for editing the biographical, professional, work-related and other user information displayed in the end-user's own profile pane 205 of FIG. 1. For example, upload image control button 368 enables the end-user to browse to a particular photograph they would like to set up to display in profile image 312 (corresponding to profile image 112 of FIG. 1). The profile image 312 can be cropped to the desired region by actuating the sliding zoom controls (364, 366) to adjust the preview zone 313 and to zoom in or zoom out as desired. Configurable controls 370 are also available to edit the items that display as user profile information 114 of FIG. 1.

Similar to profile pane 205, edit profile pane 305 includes groups 375 of profile information items 393. The right-hand side of FIG. 1 also depicts a set of controls 395 to organize the profile information items 383 in groups 375 within the end-user's profile information. For example, these controls can be used to annotate a particular profile information item 383 as confidential, personal, incorrect, etc. In the preferred embodiment, the end-user is able to simultaneously view all of the profile information item groups 375 that constitute the end-user's profile information. Upon exiting the edit profile view, the edited groups 375 become manifest as profile information items groups 118 of FIG. 1. In addition, the various profile information items 393 can be manually moved by the end-user from one group 375 to another. In one embodiment this can be performed by selecting and dragging, or other functionally equivalent actions. Such actions described above indicate to the system the user's preference for the move profile information items 383 to be shown together with the profile information items of the selected destination group 375. The system will persist this preference and subsequently use it to inform future decisions on the formation of profile information items groups 375 as new profile information items 383 are added, either through the product of an automatic generation of user profile process as it processes new content, or profile information items previously identified by the process but not yet subjected to privacy controls from the end-user.

In addition, end users may remove certain profile information items 383 from the searchable form of their automatically generated user profiles. To do this, the end-user can click controls 395 so seated with a particular profile information item 383 in order to remove it. When this happens, the system provides the user with an opportunity select the reason for the removal for use in future decisions on processing new profile information items 383 to include or exclude them from the user's profile information. The system may also collate data regarding moves and removal of a confirmation items 383, and the reasons for removal, across several end-user's in order to make macro-level determinations about the profile information items that may or may not be suitable to appear in automatically generated user profiles for all end users or certain groups of similar end users.

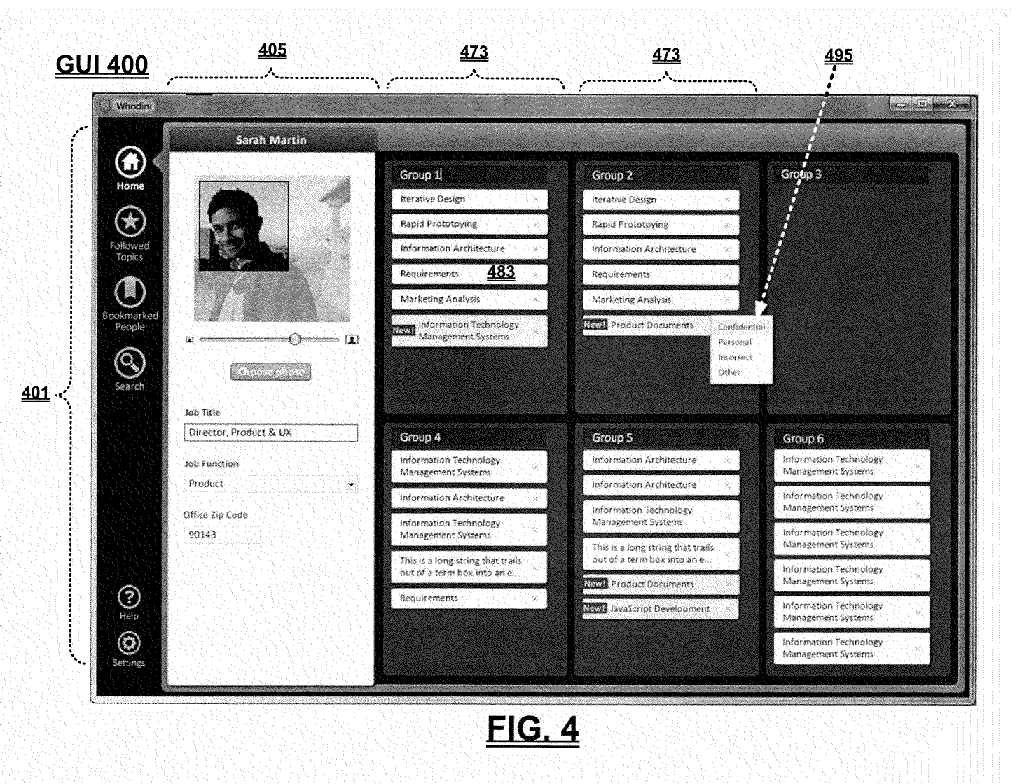

FIG. 4 depicts an example embodiment of an edit profile view in a graphical user interface corresponding to the embodiment of FIG. 3. The illustrated embodiment depicts an edit profile view of the graphical user interface 401 that includes main navigation controls 401 and edit profile pane 405. As in FIG. 3, edit profile pane 405 contains various configurable user profile information as well as editable profile information items 483. In addition, this embodiment also depicts a set of controls 495 to organize the profile information items 383 in groups 375 within the end-user's profile information. For example, these controls can be used to annotate a particular profile information item 383 as confidential, personal, incorrect, etc as shown in the illustration. These annotations will then be used as feedback to the system in order to train the system functions for use in future automatic generation of user profiles.

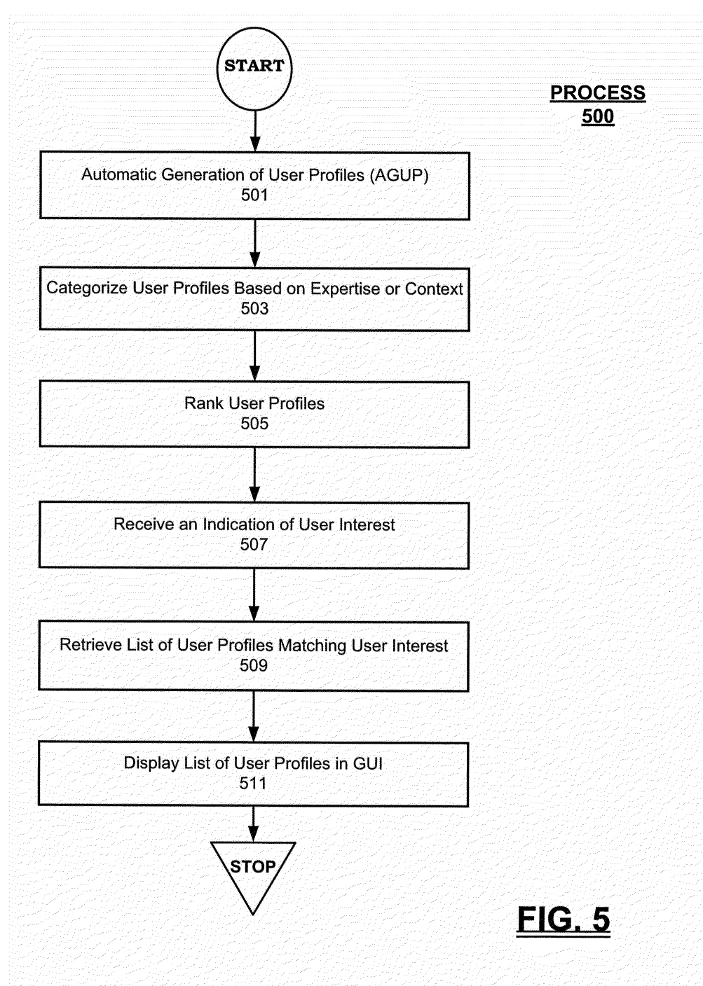

FIG. 5 depicts an illustrative process for interacting with a graphical user interface configured to display automatically generated user profiles according to one embodiment. Process 500 begins at operation 501 with automatic generation of user profiles (“AGUP”). Process 500 continues with operation 503 where the user profiles are categorized based on expertise or context associated with the end-user. In at least certain embodiments, these user profiles can also be ranked based on the strength of each user profile's relationship with the particular expertise or context (operation 505). The system then receives an indication of an interest of the end-user (operation 507). As discussed previously, this indication can be in the form of selecting on a profile information item (e.g. item 120 of FIG. 1) within a user's profile pane 105, receiving a search query from the user, or receiving a search context, or any combination of these. Process 500 continues at operation 509 where the system retrieves a list of automatically generated user profiles matching the user interest. This list of user profiles is then displayed to the end-user in a graphical user display (operation 511). This completes process 500 according to one embodiment.

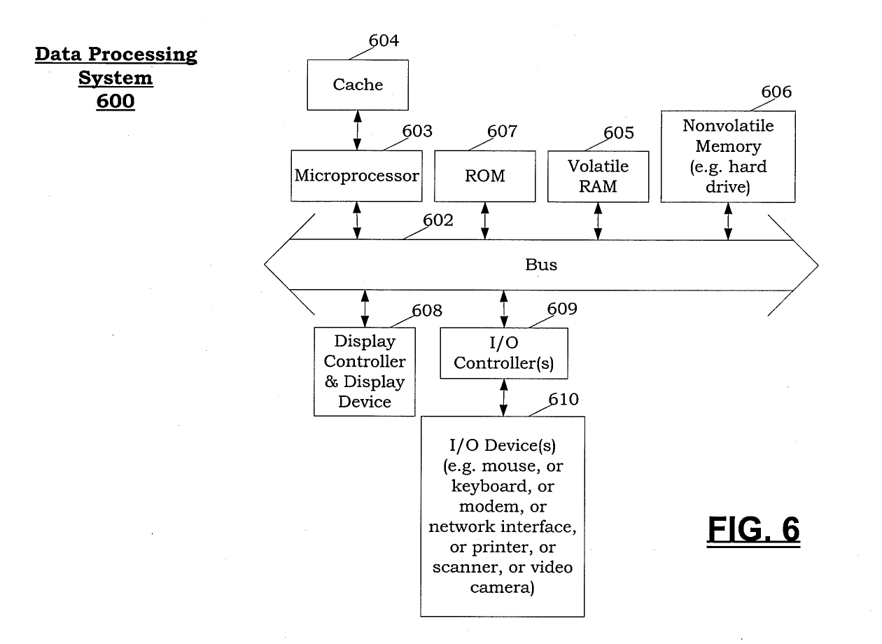

FIG. 6 illustrates an illustrative data processing system upon which the methods of various embodiments may be implemented. While FIG. 6 illustrates various components of a data processing system, it is not intended to represent any particular system or architecture thereof; or any manner of interconnecting the components, as such details are not germane to this description. It will be appreciated that network computers and other data processing systems, which have fewer components or more components may also be used. The data processing system of FIG. 6 may, for example, be a workstation, a personal computer (PC) running a MS Windows operating system, a Macintosh, or a mobile wireless device such as a smartphone or PDA, among others.

As shown in FIG. 6, data processing system 601 includes a system bus 602 which is coupled to a microprocessor 603, a read-only memory (ROM) 607, a volatile random access memory (RAM) 605, and other non-volatile memory 606 (such as electronic or magnetic disk storage). The microprocessor 603, which may be any processor designed to execute an instruction set, is coupled to cache memory 604 as shown. The system bus 602 interconnects these various components together and may also interconnect components 603, 607, 605, and 606 to a display controller and display device 608, and to peripheral devices such as I/O devices 610, keyboards, modems, network interfaces, printers, scanners, video cameras, and other devices which are well known in the art. Generally, I/O devices 610 are coupled to the system bus 602 through an I/O controller 609. Volatile RAM 605 can be implemented as dynamic RAM (“DRAM”), which requires power continually in order to refresh or maintain the data in the memory or any other type of volatile RAM. The non-volatile memory 606 can any type of memory system that maintains data after power is removed from the system.

While FIG. 6 shows that the non-volatile memory 606 is a local device coupled directly to the components of the data processing system, it will be appreciated that this description is not so limited and may utilize a non-volatile memory remote from the system, such as a network storage device coupled to the data processing system 600 through a wired or wireless network. The system bus 602 may further include one or more buses connected to each other through various bridges, controllers or adapters (not shown) as is well known in the art. Additionally, it will be understood that the various embodiments described herein may be implemented with data processing systems which have more or fewer components than system 600.

The data processing systems described herein may be specially constructed for specific purposes, or they may comprise general purpose computers selectively activated or configured by a computer program stored in the computer's memory. Such a computer program may be stored in a computer-readable medium. A computer-readable medium can be used to store software instructions, which when executed by the data processing system, causes the system to perform the various methods of this description. A computer-readable medium may include any mechanism that provides information in a form accessible by a machine (e.g., a computer, network device, PDA, or any device having a set of one or more processors). For example, a computer-readable medium may include any type of disk including floppy disks, hard drive disks (HDDs), solid-state devices (SSDs), optical disks, CD-ROMs, and magnetic-optical disks, ROMs, RAMs, EPROMs, EEPROMs, other flash memory, magnetic or optical cards; or any type of media suitable for storing instructions in an electronic format.

Throughout the foregoing description, and for the purposes of explanation, numerous specific details were set forth in order to provide a thorough understanding of the disclosed embodiments. It will be apparent to one skilled in the art, however, that various embodiments may be practiced without some of these specific details. Although embodiments which incorporate the techniques in this description have been shown and described in detail herein, those skilled in the art can readily devise many other varied embodiments that still incorporate these techniques. Embodiments of the invention may include various operations as set forth above or fewer operations or more operations, as well as operations in an order. Accordingly, the scope and spirit of the invention should be judged in terms of the claims which follow as well as the legal equivalents thereof.

1. A method of displaying user profiles to an end-user, the method comprising:
parsing user data and electronic communications within an organization into a list of keywords and phrases indicating each user's expertise or a context associated with each user;
automatically generating a set of user profiles based on the parsing of user data, wherein each user profile includes information categorized based on a given expertise or context;
ranking each of the user profiles in the set based on its strength of relationship with the expertise or context;
searching for user profiles having attributes that match a known interest of the end-user and generating a list of the matching user profiles; and
displaying the list of user profiles that match the known interest of the end-user in rank order based on the degree that the information in the user profiles matches information contained in a user profile of the end-user.

2. The method of claim 1, wherein the known interest is based on the expertise or context associated with the end-user profile information.

3. The method of claim 2, wherein the known interest is further based on a search query input by the end-user.

4. The method of claim 3, wherein the known interest is further based on a search context input by the end-user.

5. The method of claim 1, wherein the user profiles are displayed in a graphical user interface.

6. The method of claim 1, wherein displaying the list of user profiles further comprises displaying profile information items organized in groups based on expertise or context.

7. The method of claim 1, further comprising:
receiving feedback from users; and
annotating the user profiles based on the feedback for use in future automatic generation of user profiles.

8. The method of claim 7, further comprising training functions associated with automatically generating user profiles in response to the feedback.

9. The method of claim 1, further comprising receiving input from the end-user to control the display of user profile information irrespective of its relevancy to the expertise or context.

10. A device configured to display user profile information to an end-user comprising:
a profile building unit configured to parse user data and electronic communications within an organization into a list of keywords and phrases indicating each user's expertise or a context associated with each user and to automatically generate a set of user profiles organized into a given expertise or context;
a scoring unit configured to rank each of the user profiles in the set based on its strength of relationship with the expertise or context;
a search engine adapted to locate user profiles having attributes that match a known interest of the end-user and to generate a list of the matching user profiles; and
a graphical user interface configured to display the list of-user profiles that match a known interest of the end-user in rank order based on the degree that the information contained in the user profiles matches information contained in a user profile of the end-user.

11. The device of claim 10, wherein the graphical user interface includes a profile view for searching and displaying user profiles relevant to the expertise or context.

12. The device of claim 10, wherein the graphical user interface includes an edit profile view for annotating and controlling display options of end-user profile information.

13. The device of claim 10, wherein the display of the user profiles includes displaying profile information items organized in groups based on expertise or context.

14. The device of claim 10, wherein the known interest is based on the expertise or context associated with the end-user profile information.

15. The device of claim 14, wherein the known interest is further based on a search query input by the end-user.

16. The device of claim 15, wherein the known interest is further based on a search context input by the end-user.

17. The device of claim 10, further comprising a competency detection unit configured to receive feedback from users and to annotate the user profiles in response to the feedback.

18. The device of claim 10, further comprising a control unit configured to receive input from the end-user and to adjust the display of user profile information in response to the input irrespective of its relevancy to the expertise or context.

19. A computer-readable storage medium that provides instructions, which when executed by a computer, causes the computer to display user profiles to an end-user, the instructions comprising:
instructions to parse user data and electronic communications within an organization into a list of keywords and phrases indicating each user's expertise or a context associated with each user;
instructions to automatically generate a set of user profiles, wherein each user profile includes information categorized based on a given expertise or context;
instructions to rank each of the user profiles in the set based its strength of relationship with the expertise or context;
instructions to search for user profiles having attributes that match a known interest of the end-user and to generate a list of the matching user profiles; and
instructions to display the list of user profiles that match the known interest of the end-user in rank order based on the degree that the information in the user profiles matches information contained in a profile of the end-user.

20. The computer-readable storage medium of claim 19, wherein the user profiles are displayed in a graphical user interface.

21. The computer-readable storage medium of claim 19, wherein the instructions to display the list of user profiles further comprises instructions to display profile information items organized in groups based on expertise or context.

22. The computer-readable storage medium of claim 19, wherein the known interest is based on the expertise or context associated with the end-user profile information.

23. The computer-readable storage medium of claim 19, wherein the known interest is further based on a search query input by the end-user.

24. The computer-readable storage medium of claim 19, further comprising:
instructions to receive feedback from users; and
instructions to annotate the user profiles based on the feedback for use in future automatic generation of user profiles.

25. The computer-readable storage medium of claim 19, further comprising instructions to receive input from the end-user to control the display of user profile information irrespective of its relevancy to the expertise or context.

26. The method of claim 1, further comprising mediating the list of matching user profiles by further matching information in the user profiles with the information contained in the end-user's profile.

27. The device of claim 10, wherein the search engine is further adapted to mediate the list of matching user profiles by further matching information in the user profiles with information contained in the end-user's profile.

28. The computer-readable storage medium of claim 19, further comprising instructions to mediate the list of matching user profiles by further matching the user profiles with information contained in the end-user's profile.
